(19) United States
(12) Patent Application Publication
(10) Pub. No.: US 2026/0172943 A1
(43) Pub. Date: Jun. 18, 2026

(54) ENERGY COST VALUE FRAMEWORK FOR SYSTEM-LEVEL NETWORK ENERGY SAVINGS

(71) Applicant: QUALCOMM Incorporated, San Diego, CA (US)

(72) Inventors: Shuvam CHAKRABORTY, Albany, NY (US); Navid ABEDINI, Basking Ridge, NJ (US); Wenjun LI, Basking Ridge, NJ (US)

(21) Appl. No.: 18/979,486

(22) Filed: Dec. 12, 2024

(51) Int. Cl. H04W 40/10; H04W 76/28

(52) U.S. Cl. CPC H04W 40/10; H04W 76/28

(57) ABSTRACT

A method of wireless communication at a first network node, comprising: providing a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs and receiving a response indicating energy cost information of the second network node associated with the one or more attributes indicated in the request.

### INTRODUCTION

The present disclosure relates generally to communication systems, and more particularly, to wireless communication including network energy savings operation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 6G or 5G NR may be based on the 4G Long Term Evolution (LTE) standard. There exists a need for further improvements in wireless communication technology, e.g., including 5G, 6G or future wireless communication technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to an apparatus for wireless communication at a first network node, including: one or more memories; and one or more processors coupled to the one or more memories and configured to cause the first network node to: provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs; and receive a response that indicates energy cost information of the second network node associated with the one or more attributes indicated in the request.

In some aspects, the techniques described herein relate to a method of wireless communication at a first network node, including: providing a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs and receiving a response indicating energy cost information of the second network node associated with the one or more attributes indicated in the request.

In some aspects, the techniques described herein relate to an apparatus for wireless communication at a first network node, including: means for providing a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and means for receiving a response indicating energy cost information of the second network node associated with the one or more attributes indicated in the request.

In an aspect of the disclosure, a computer-readable medium is provided. The computer-readable medium (e.g., non-transitory computer-readable medium) stores computer executable code at a network node, the code when executed by one or more processors causes the first network node to: provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and receive a response that indicates energy cost information of the second network node associated with the one or more attributes indicated in the request.

In some aspects, the techniques described herein relate to an apparatus for wireless communication at a second network node, including: one or more memories; and one or more processors coupled to the one or more memories and configured to cause the second network node to: receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and provide a response indicating energy cost information of the second network node associated with the one or more attributes indicated in the request.

In some aspects, the techniques described herein relate to a method of wireless communication at a second network node, including: receiving a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and providing a response indicating energy cost information of the second network node associated with the one or more attributes indicated in the request.

In some aspects, the techniques described herein relate to an apparatus for wireless communication at a second network node, including: means for receiving a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and means for providing a response indicating energy cost information of the second network node associated with the one or more attributes indicated in the request.

In an aspect of the disclosure, a computer-readable medium is provided. The computer-readable medium stores computer executable code at a network node, the code when executed by one or more processors causes the network node to: receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and provide a response indicating energy cost information of the second network node associated with the one or more attributes indicated in the request.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a base station in communication with a UE in an access network, in accordance with various aspects of the present disclosure.

FIG. 5A illustrates an example communication flow for data collection between network nodes, in accordance with various aspects of the present disclosure.

FIG. 5B illustrates an example communication flow for data collection between network nodes with granular energy cost information, in accordance with various aspects of the present disclosure.

FIG. 6A illustrates example aspects relating to DRX, in accordance with various aspects of the present disclosure.

FIG. 6B illustrates an example communication flow between network nodes including a request to adopt a configuration or action based on energy cost information, in accordance with various aspects of the present disclosure.

FIG. 7A and FIG. 7B illustrate example communication flows between network nodes including a cell activation request and response based on energy cost information, in accordance with various aspects of the present disclosure.

FIG. 8 illustrates an example graph showing energy cost as a function of beams or SSBs, in accordance with various aspects of the present disclosure.

FIG. 9 illustrates an example communication flow between network nodes including granular energy cost information, in accordance with various aspects of the present disclosure.

FIG. 10 is a flowchart of a method associated with wireless communication, in accordance with various aspects of the present disclosure.

FIG. 11 is a flowchart of a method associated with wireless communication, in accordance with various aspects of the present disclosure.

FIG. 12 is a diagram illustrating an example of a hardware implementation for an example network entity.

FIG. 13 is an illustrative block diagram of an example machine learning (ML) model represented by an artificial neural network (ANN), in accordance with various aspects of the present disclosure.

FIG. 14 is an illustrative block diagram of an example ML architecture for wireless communications, in accordance with various aspects of the present disclosure.

FIG. 15 is an illustrative block diagram of an example ML architecture of first wireless device in communication with second wireless device, in accordance with various aspects of the present disclosure.

### DETAILED DESCRIPTION

Some wireless communication systems may employ network energy saving (NES) aspects at network nodes or cells. For example, an NES mode may refer to a mode of a network node (e.g., base station or components of a base station) or a mode of a cell that saves power at the network node. As an example, such network nodes may use signaling that is configured to save energy at the network node. For example, an NES mode may refer to a mode of a network node or of one or more cells provided by the network node, which saves power at the network node. In some aspects, a network node or a cell may operate at times in a first mode that uses a higher amount of power at the network node, and at other times, the network node or cell may operate in a second mode (e.g., an NES mode) that uses a reduced amount of power at the network node.

A system-wide NES scheme or NES strategy may be implemented to coordinate NES operation of one or more network nodes within a wireless communication system. A central entity may make NES decisions for a set of network nodes. The system-wide NES strategy may be implemented based on various approaches. In a centralized approach, a central network entity may determine a configuration for various base stations and/or cells in the system to implement, or coordinate, an NES scheme. In some examples, the central entity may be an application in a service management and orchestration (SMO) platform. For example, the central entity may coordinate the NES operation of various network nodes (e.g., various base stations or components of base stations) so that the operation of a particular network node does not burden or unfairly affect other network nodes that may be caused to compensate for the NES operation of the particular network node.

In a distributed approach for system-wide NES, individual base stations may communicate with each other (e.g., over an Xn interface) to exchange information to implement an NES scheme (e.g., a coordinated NES scheme). For example, network nodes (such as base stations) may exchange information to enable individual network node to make informed decisions about their NES operation for one or more cells. This enables an individual network nodes to make distributed NES decisions that avoid a burden to neighboring network nodes, even without coordination through a central entity. Aspects presented herein help to improve a distributed NES implementation by providing a granular set of parameters for energy cost prediction, energy cost estimation, energy cost calculation, and/or energy cost reporting that can be exchanged between network nodes (e.g., base stations or one or more components of base stations).

As an example, network nodes may exchange information that informs neighbor network nodes of an energy cost or energy savings that would be experienced by the network nodes based on use of a particular configuration or performance of a particular action. Aspects presented herein help to improve a distributed NES implementation by providing a granular set of parameters for energy cost information that can be exchanged between network nodes. An “energy cost” refers to an energy that is used by the network node for operation of the network node or for providing wireless communication for one or more cells. In some aspects, an energy cost may refer to an increase in energy used by the network node, and an energy efficiency may refer to a reduction in energy used by the network node. In some aspects, a decrease in energy used by the network node may be referred to as a negative energy cost. In some aspects, the energy cost may refer to an overall energy used at the network node for operation. In some aspects, the energy cost may be referred to as an energy state (e.g., of the network node or one or more cells of the network node). The energy cost information may indicate an amount of energy used, or to be used, by the network node or may indicate a level of energy (e.g., high, medium, or low) used by the network node for operation to provide one or more cells. As an example, the EC can take a value from 0 to 10000. The meaning of the values may be left to implementation, or may be determined by operations, administration and maintenance (OAM), for example. For example, the energy cost information may include one or more of an energy cost prediction (e.g., a prediction of an amount of energy that would be used by the network node), energy cost estimation (e.g., an estimation of an amount of energy used by the network node), energy cost calculation (e.g., a calculation or measurement of energy used by the network node), and/or energy cost reporting (a report of energy used by the network node).

For example, the indicated energy cost information may be associated with one or more attributes of a network node, or one or more cells provided by the network node As an example, the one or more attributes may include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, and/or a group handover of multiple UEs.

In some aspects, an energy cost metric of a network node (or for one or more cell(s)) may be considered in connection with NES determinations or decisions. As an example, an energy cost of a network node/cell(s), may be considered as part of a model, e.g., an artificial intelligence (AI)/machine learning (ML) model. Aspects presented herein provide added efficiency and flexibility to an energy cost framework for NES operation within a communication system. In some examples, the aspects presented herein may include a model based approach, e.g., with an AI/ML model. In some examples, the aspects presented herein may be implemented without a model, e.g., without an AI/ML model.

A network node (e.g., which may also be referred to as a RAN node, a network entity, an NG-RAN node, or a base station) may run, e.g., use, an algorithm for NES decisions, e.g., for determining whether to employ an NES mode and/or which NES mode to employ at a particular time or under particular conditions. In some aspects, the algorithm may be an AI/ML algorithm, e.g., and may use an AI/ML model. As an input to the model (e.g., for inference), the network node may collect energy cost information from neighboring nodes (e.g., from neighboring base stations) including one or more of a current energy cost or energy efficiency of the neighbor node (e.g., an energy efficiency experienced by, measured by, or calculated by the neighbor node rather than a predicted energy efficiency), a predicted energy efficiency of the neighbor node, and/or a current energy state (e.g., high, medium, or low) experienced by or determined by the neighbor node. The output (e.g., inference) from the model may include an NES strategy for the network node and a corresponding predicted energy efficiency or energy cost.

In some examples, the exchange of energy cost information improves coordination of NES operation among network nodes by enabling neighboring network nodes to make informed decisions about their individual node operation, which may include NES operation at times. For example, the exchange of energy cost information enables an individual network node to make distributed NES decisions (e.g., individual NES decisions by individual network nodes rather than receiving central NES decisions from a central entity) in a coordinated way that avoid or reduce energy costs to neighboring network nodes, even without coordination through a central entity. The coordination enables more efficient and coordinated operation of network nodes, which improves distributed NES decisions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

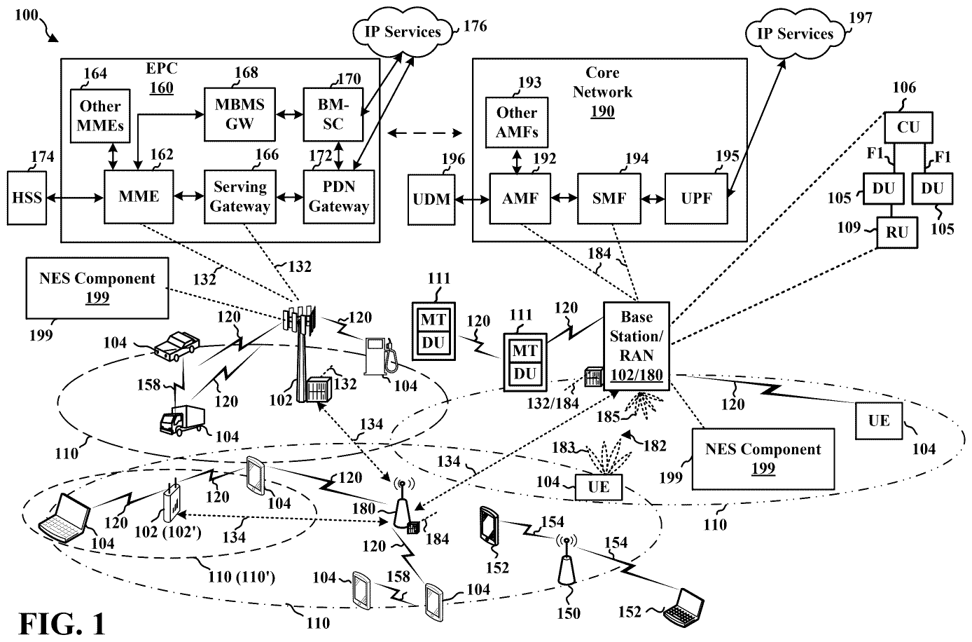

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions 185. The UEs 104 may receive the beamformed signal from the base stations 180 in one or more receive directions 183. The UEs 104 may also transmit a beamformed signal to the base stations 180 in one or more transmit directions (e.g., 183). The base stations 180 may receive the beamformed signal from the UEs 104 in one or more receive directions (e.g., 185). The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the base station 180 may have an NES component 199 that may be configured to provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs and receive a response indicating energy cost information of the second network node associated with the one or more attributes indicated in the request. In some aspects, the NES component 199 may be configured to receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and provide a response indicating energy cost information of the second network node associated with the one or more attributes indicated in the request.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

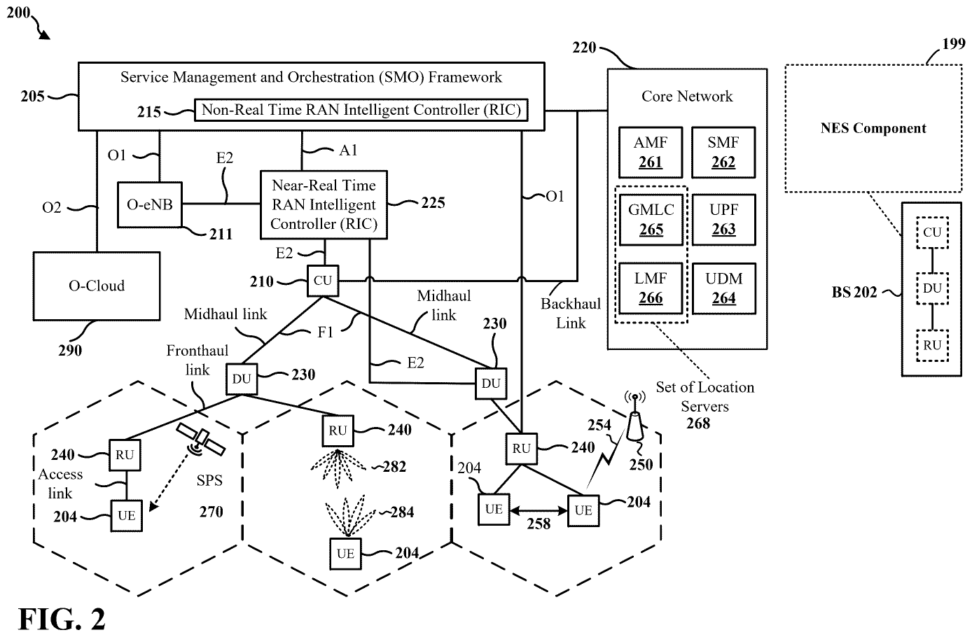

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit—User Plane (CU-UP)), control plane functionality (i.e., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, a base station 202, or one or more components of the base station 202, may include an NES component 199 configured to provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs and receive a response indicating energy cost information of the second network node associated with the one or more attributes indicated in the request. In some aspects, the NES component 199 may be configured to receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and provide a response indicating energy cost information of the second network node associated with the one or more attributes indicated in the request.

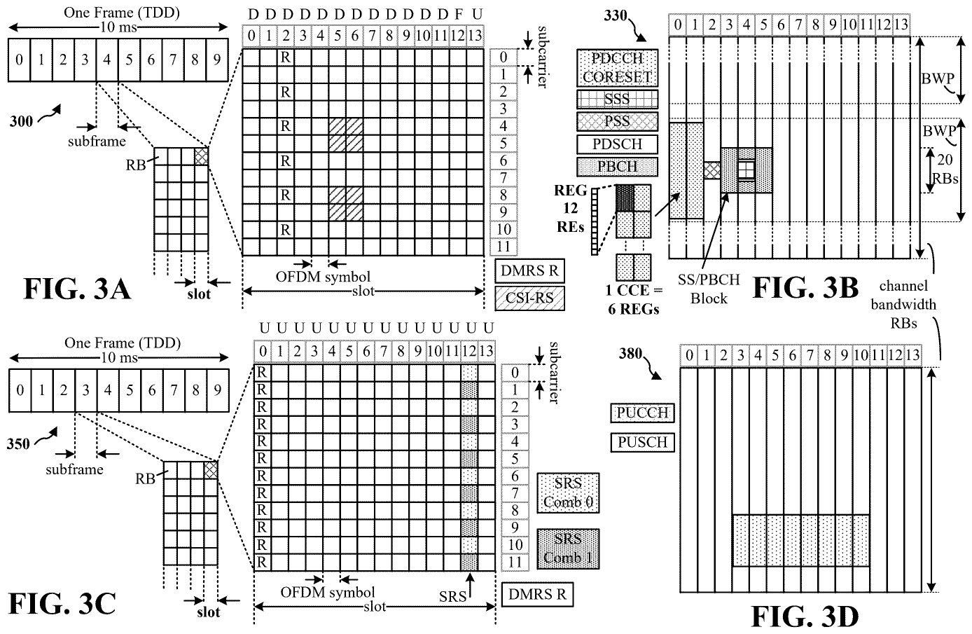

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. As shown in Table 1, the subcarrier spacing may be equal to 2^{μ*}15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The PDCCH carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The PDSCH carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

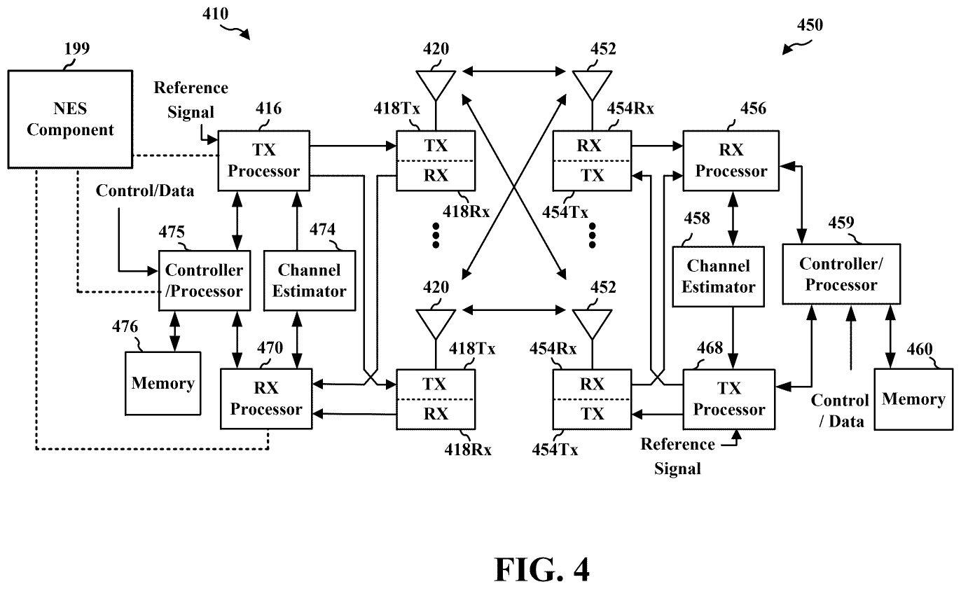

FIG. 4 is a block diagram that illustrates an example of a first wireless device that is configured to exchange wireless communication with a second wireless device. In the illustrated example of FIG. 4, the first wireless device may include a base station 410, the second wireless device may include a UE 450, and the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 416, the RX processor 470, and the controller/processor 475 may be configured to perform aspects in connection with the NES component 199 of FIG. 1.

Some wireless communication systems may employ network energy saving aspects, and may provide network energy saving (NES) nodes or NES cells. Such network nodes (e.g., base stations or one or more components of a base station) or such cells may support energy savings operation and/or energy saving modes. As an example, such network nodes may use signaling that is configured to save energy at the network node. For example, an NES mode may refer to a mode of a base station or of a cell that saves power at the base station. At times, the base station may operate in a first mode that uses a higher amount of power at the base station, and at other times may operate in a second mode (e.g., NES mode) that uses a reduced amount of power at the base station.

Different aspects of wireless communication may be modified to reduce energy use at the network node based on the NES mode, e.g., including modified SSB transmission such as a reduction in SSB transmission, an increase in SSB periodicity, or a use of on-demand SSB transmission; cell discontinuous transmission (DTX)/discontinuous reception (DRX); cell deactivation; beam deactivation; change in periodicity of system information such as use of on-demand SIB transmission (e.g., SIB1 transmission in response to a UE request); adaptations to RACH resources such as reduced RACH occasions; adaptations to paging; adaptations or reductions to common signals or common channel transmissions (e.g., SSB, PRACH resources, paging, etc.), or handover of UEs.

A system-wide NES scheme or NES strategy may be implemented to coordinate NES operation of one or more network nodes within a wireless communication system. The system-wide NES strategy may be implemented based on various approaches. In a centralized approach, a central network entity may determine a configuration for various base stations and/or cells in the system to implement, or coordinate, an NES scheme. In some examples, the central entity may be an application in a service management and orchestration (SMO) platform. For example, the central entity may coordinate the NES operation of various network nodes (e.g., various base stations or components of base stations) so that the operation of a particular network node does not burden or unfairly affect other network nodes that may be caused to compensate for the NES operation of the particular network node.

In a distributed approach for system-wide NES, individual base stations may communicate with each other (e.g., over an Xn interface) to exchange information to implement an NES scheme (e.g., a coordinated NES scheme). For example, base stations may exchange information to enable individual base stations to make informed decisions about their NES operation. This enables an individual base station to make distributed NES decisions that avoid a burden to neighboring base stations, even without coordination through a central entity. Aspects presented herein help to improve a distributed NES implementation by providing a granular set of parameters for energy cost prediction, energy cost estimation, energy cost calculation, and/or energy cost reporting that can be exchanged between network nodes (e.g., base stations or components of base stations).

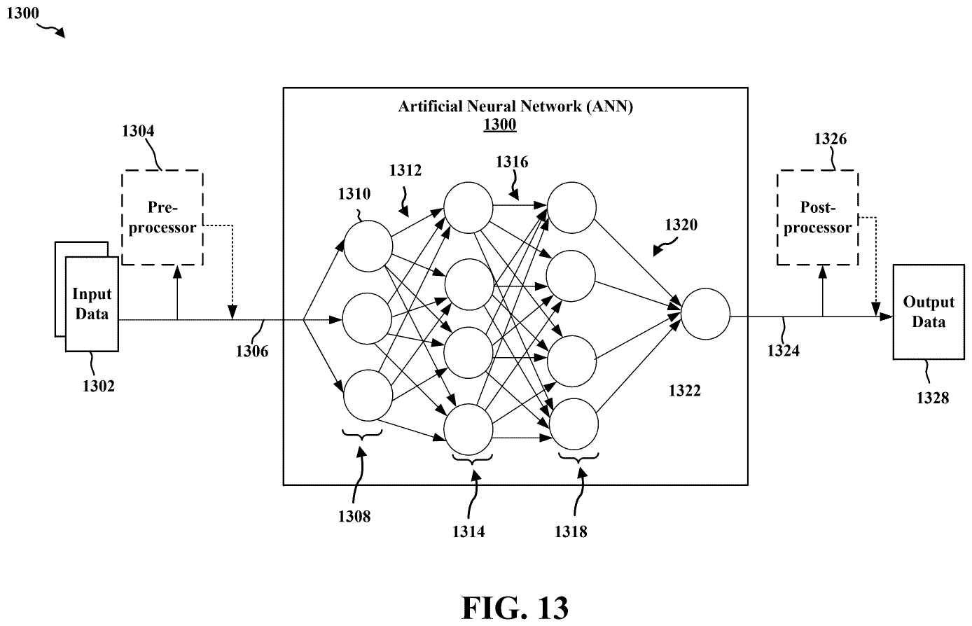

In some aspects, an energy cost metric of a network node may be considered for NES determinations or decisions. As an example, an energy cost of a network node, such as a base station, may be considered as part of a model, e.g., an artificial intelligence (AI)/machine learning (ML) model. Example aspects of an AI/ML model that may use energy cost from a base station as input information to obtain output determinations regarding NES operation are described in connection with FIGS. 13-15. Aspects presented herein provide added efficiency and flexibility to an energy cost framework for NES operation within a communication system. In some examples, the aspects presented herein may include a model based approach, e.g., with an AI/ML model. In some examples, the aspects presented herein may be implemented without a model, e.g., without an AI/ML model.

A network node (e.g., which may also be referred to as a RAN node, a network entity, an NG-RAN node, or a base station) may run, e.g., use, an algorithm for NES decisions, e.g., for determining whether to employ an NES mode and/or which NES mode to employ at a particular time or under particular conditions. In some aspects, the algorithm may be an AI/ML algorithm, e.g., and may use an AI/ML model. As an input to the model (e.g., for inference), the network node may collect energy cost information from neighboring nodes (e.g., from neighboring base stations) including one or more of a current energy cost or energy efficiency of the neighbor node (e.g., an energy efficiency experienced by, measured by, or calculated by the neighbor node rather than a predicted energy efficiency), a predicted energy efficiency of the neighbor node, and/or a current energy state (e.g., high, medium, or low) experienced by or determined by the neighbor node. For example, a current energy efficiency may be based on a measurement of an amount of energy used by the network node for operation to provide one or more cells for wireless communication, and a current energy state may correspond to a level (e.g., high, medium, or low) of energy used by the network node for operation to provide one or more cells. In some aspects, an energy cost may refer to an increase in energy used by the network node, and an energy efficiency may refer to a reduction in energy used by the network node. The output (e.g., inference) from the model may include an NES strategy for the network node and a corresponding predicted energy efficiency or energy cost.

In some aspects, a network node may ask a neighbor node to share its energy cost information. In some aspects, the energy cost information may be for operation of the network node to provide wireless communication for one or more cells. In some aspects, the energy cost information may be associated with operation of the network node to provide a particular cell or to provide a set of one or more cells. As one non-limiting example, the network node may be a first base station (such as a first gNB), and the neighbor node may be a second base station (such as a second gNB). In response, the neighbor node may provide (e.g., signal) its energy cost (which may be referred to as an energy cost (EC)) to the network node. As an example, the EC can take a value from 0 to 10000. The meaning of the values may be left to implementation, or may be determined by operations, administration and maintenance (OAM). The NES action may be an implementation by the network node, in some aspects.

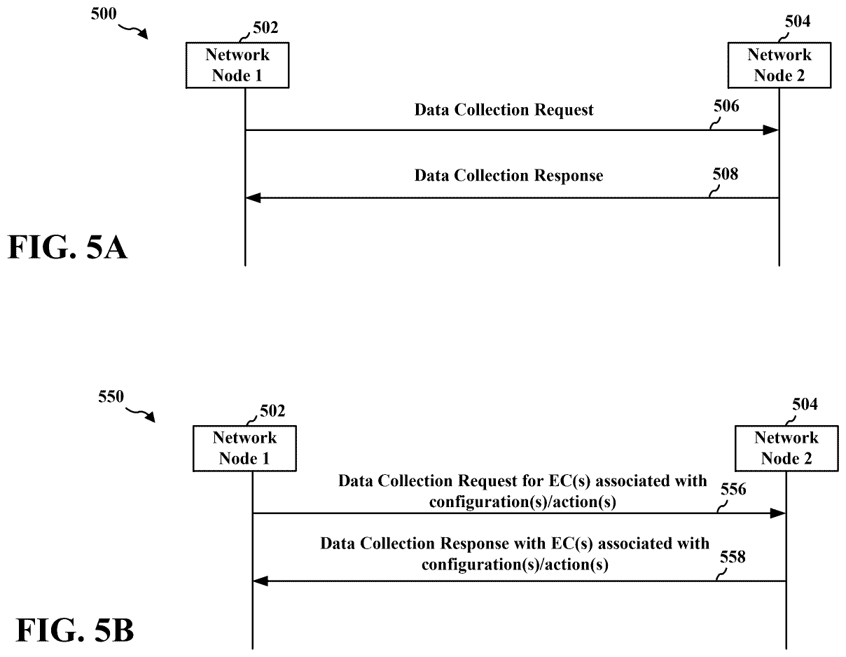

FIG. 5A illustrates an example of a data collection reporting operation 500 between two network nodes. As illustrated at 506, a first network node 502 (e.g., which may also be referred to as a first RAN node, a first NG-RAN node, a first network entity, and/or a first base station) initiates the data collection reporting by sending a data collection request 506 to a second network node 504 (e.g., which may also be referred to as a second RAN node, a second NG-RAN node, a second network entity, and/or a second base station) to start information reporting. This procedure may be used by a first network node 502 to request from another network node (e.g., 504) the reporting of information to support, e.g., AI/ML in the first network node 502). The procedure may use non-UE-associated signalling for the request and the response.

Upon receipt of the request 506, the second network node 504 may initiate the requested information reporting according to the parameters given in the request. In some aspects, the request 506 may include an indication to start or stop the reporting. The second network node may report, or stop reporting, based on the indication. In some aspects, the request may indicate a cell to report the information. In some aspects, the request may indicate timing information for reporting the requested information, such as a reporting periodicity or predicting timing information.

In some aspects, the first network node 502 may indicate in the request (e.g., 506) that the first network node is requesting an energy cost of the second network node. At 508, the second network node 504 provides (e.g., transmits or otherwise signals) a data collection response. If the request, at 506, indicated a request for energy cost, the second network node 504 may indicate its energy cost in the response, at 508. In some aspects, the energy cost provided in the response may be considered a node associated information result and may be indicated as an integer value between 0 to 10000. The integer value may be referred to as a “node level measured energy consumption index value.” The value 0 (e.g., node level measured energy consumption index value 0) may indicate the minimum measured energy consumption, and the value 10000 (e.g., node level measured energy consumption index of 10000) may indicate a maximum measured energy consumption. In some aspects, the first network node 502 may use the data collection response (e.g., including the energy cost indicted by the second network node) for AI/ML purpose such as for model training and/or model based inference.

An energy cost corresponds to an attribute of a network node at a given time. The network node may correspond to a base station, RAN node, or gNB, for example. Aspects presented herein provide for an energy cost with additional granularity. As an example, a network node may provide information in the data collection procedure about an energy cost that is associated with a particular configuration and/or action of the network node.

FIG. 5B illustrates an example communication flow 550 between a first network node 502 and a second network node 504 including a request 556 for the energy cost information. The first network node 502 sends the request 556 for an energy cost experienced by (or predicted for) the second network node 504 and associated with a particular configuration and/or a particular action of the second network node 504. In response to receiving the request 556, the second network node 504 determines, measures, predicts, or otherwise collects the indicated energy cost associated with the particular configuration or action. The second network node 504 sends a response 558 to the first network node 502, where the response 558 reports the energy cost for the indicated configuration and/or action. The request and/or response in FIG. 5B may be exchanged over an Xn interface between the network nodes. In some aspects, the second network node 504 may indicate more than one energy cost, e.g., an energy cost for each of one or more configurations and/or one or more actions indicated in the request 556. The data collection request (e.g., 556) and the data collection response (e.g., 558) may be exchanged over an Xn interface between the two network nodes (e.g., an Xn interface between the first network node 502 and the second network node 504). In some aspects, the network nodes may exchange energy cost information (e.g., and the first network node may report its energy cost information to the second network node).

In some examples, the second network node 504 may report, at 558, an energy cost associated with a particular configuration of the second network node 504. In some aspects, the second network node 504 may report (e.g., send) its energy cost information associated with a particular cell or a group of cells of the second network node. A cell corresponds to a configuration of a network entity or a logical boundary of coverage by the network node (e.g., base station) associated with a frequency (e.g., having a frequency bandwidth) and associated procedures including signaling to connect to the cell. The request 556 may include a request for energy cost information for a particular cell or for a group of cells (e.g., by indicating an identifier of the particular cell, an identifier for the group of cells, or an identifier for each cell for which energy cost information is requested). The second network node 504 may then report the energy cost information for the indicated cells.

In some aspects, the first network node 502 may request energy cost information of the second network node 504 as an energy cost per cell. The second network node 504 may respond by sending an energy cost per cell (of the cells provided by, or supported by, the second network node).

In some aspects, the second network node may report energy cost information associated with a particular beam or a group of beams of the second network node 504. For example, the first network node 502 may request energy cost information from the second network node 504 associated with a particular beam and may indicate the beam in the request. The beam may be indicated by an identifier, a QCL relationship, or an associated signal, for example. As an example, the second network node 504 may report an energy cost associated with an SSB beam. An SSB beam refers to a beam used by the second network node to transmit an SSB (e.g., such as described in connection with FIG. 3B). In some aspects, the beam may be identified by reference to an SSB index.

In some aspects, the request 556 may indicate a request for energy cost information associated with a group of multiple beams. The request may include an identifier, index, or other information that identifies each of the multiple beams or that identifies the group associated with the multiple beams. The second network node 504 may the report an energy cost of the second network node associated with the group of multiple beams. In some aspects, the group of beams may include a subset of beams supported by the second network node 504, for example.

In some aspects, the first network node 502 may request energy cost information associated with one or more coverage states of the second network node 504. The second network node 504 may indicate an energy cost associated with each of the indicated coverage state(s). The second network node 504 may report an energy cost associated with a particular coverage state or an energy cost for each of multiple potential coverage states.

In some aspects, the second network node 504 may provide an energy cost associated with a single action or a single configuration. In some aspects, the second network node 504 may report multiple energy costs, each energy cost associated with an action or a configuration. In some aspects, the second network node 504 may report an energy cost associated with any combination of configurations, e.g., any combination of cell, group of cells, beam, group of beams, and/or coverage state, among other examples. By reporting energy cost information associated with a particular configuration or a particular action, the second network node 504 enables the first network node 502 to make an NES decision with a more comprehensive understanding of the effect on neighboring network nodes, including the second network node 504.

In some examples, the second network node 504 may report an energy cost associated with a particular action performed by the second network node 504. In some aspects, the action may include a modification of a configuration. For example, the first network node 502 may indicate a request for an energy cost associated with a cell activation and/or a cell deactivation at the second network node 504. The second network node 504 may respond by reporting an energy cost at the second network node associated with the indicated cell activation and/or a cell deactivation. In some aspects, the request 556 may indicate a particular cell or a group of cells (e.g., by indicating an identifier of the particular cell, an identifier for the group of cells, or an identifier for each cell for which energy cost information is requested in association with the cell activation/deactivation).

In some aspects, the first network node 502 may request the energy cost at the second network node associated with a beam activation and/or a beam deactivation. The second network node 504 may respond by reporting the energy cost associated with the indicated beam activation and/or beam deactivation. The beam(s) for which the energy cost is requested for the activation/deactivation may be indicated in the request 556 by an identifier, a QCL relationship, or an associated signal, for example. In some aspects, the beam may be indicated based on an SSB index.

In some aspects, the first network node 502 may indicate a request for energy cost information of the second network node 504 for a beam reconfiguration. The second network node 504 may respond by reporting the energy cost associated with a beam reconfiguration. In some aspects, the first network node 502 may indicate a request for energy cost information of the second network node 504 for a power reconfiguration (e.g., changing a transmission power of the signals transmitted by the second network node). The second network node 504 may respond by reporting the energy cost associated with a power reconfiguration at the second network node 504.

In some aspects, the first network node 502 may request energy cost information of the second network node 504 associated with a change of periodicity. The second network node 504 may respond by reporting the energy cost associated with the indicated change of periodicity. Among other examples, the change of periodicity may include a change in a periodicity of SSB transmissions, system information transmissions, SIB transmission such as SIB1 transmission, RACH resources, paging, or downlink transmissions such as PDCCH.

In some aspects, the first network node 502 may request energy cost information of the second network node 504 associated with an activation and/or deactivation of an on-demand system information or SIB, such as on-demand SIB1 transmission. In some aspects, the first network node 502 may request energy cost information of the second network node 504 associated with an activation and/or deactivation of an on-demand SSB. The second network node 504 may respond by reporting the energy cost associated with the indicated activation and/or a deactivation of on-demand system information.

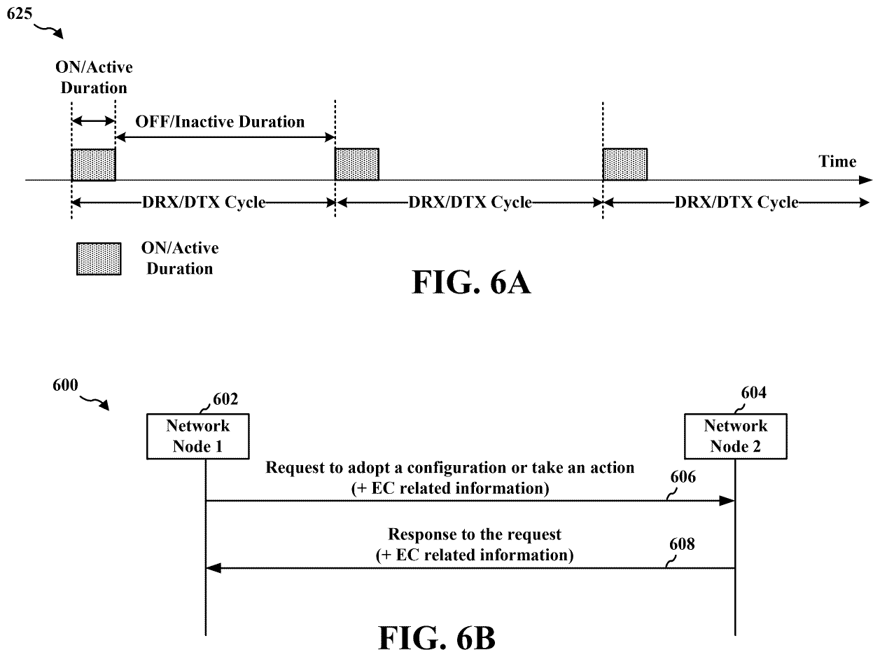

In some aspects, the first network node 502 may indicate a request for energy cost information of the second network node 504 associated with an activation and/or deactivation of a cell configuration, such as a cell DTX/DRX configuration. With a cell DTX/DRX configuration, the network node may use periodic OFF durations or inactive periods when the cell does not transmit and/or receive. For example in a cell DTX configuration, the cell may skip, at least a subset of, transmissions during the OFF duration (which may be referred to as inactive duration), and may transmit transmissions during the ON duration (which may be referred to as an active duration). Similarly, with DRX, the cell may skip, at least some, reception during an OFF duration or inactive duration and may monitor for transmissions or receive transmissions during the ON duration or active duration. FIG. 6A illustrates an example timeline 625 illustrating periodic ON/OFF durations or active/inactive durations that may be used in connection with DTX/DRX. A cell DTX or DRX operation may save power at a network node by reducing power consumption at a transceiver. The second network node 504 may respond by reporting the energy cost associated with the indicated activation and/or deactivation of a cell configuration such as activation or deactivation of a cell DTX or DRX configuration.

In some aspects, the first network node 502 may indicate a request for energy cost information of the second network node 504 associated with a RACH adaption at the second network node, such as a change in RACH resources or RACH occasions. The second network node 504 may respond by reporting the energy cost associated with the indicated RACH adaptation.

In some aspects, the first network node 502 may indicate a request for energy cost information of the second network node 504 associated with a paging adaption at the second network node. The second network node 504 may respond by reporting an energy cost associated with the indicated paging adaptation.

In some aspects, the first network node 502 may indicate a request for energy cost information of the second network node 504 associated with a handover of one or more UEs, such as a group handover of multiple UEs. The second network node 504 may respond by reporting energy cost associated with the indicated handover. For example, the second network node 504 may report an energy cost associated with a group handover of multiple UEs.

In some aspects, the first network node 502 may indicate a request for an energy cost associated with a single action at the second network node 504 and/or an energy cost associated with any combination of actions at the second network node 504. For example, the first network node 502 may indicate a request for any combination of actions including one or more of a cell activation/deactivation, a beam activation/deactivation, a beam reconfiguration, a power reconfiguration, a change of periodicity, an activation/deactivation of on-demand SIB1 operation, an activation/deactivation of an on-demand SSB operation, an activation/deactivation of cell DTX/DRX, a RACH adaptation, a paging adaptation, and/or a group handover of UEs, among other examples.

In some aspects, the second network node 504 may report, at 558, a predicted energy cost value, e.g., a prediction of the energy cost that would be experienced by the second network node that is predicted before the second network node actually performs the associated action. In some aspects, the second network node 504 may indicate the energy cost as a relative cost of the associated action in comparison to (or relative to) a current energy cost. In some aspects, the second network node 504 may indicate the energy cost as an additional cost, or a cost delta, of the associated action in comparison to a current energy cost of the second network node 504.

In some aspects, the energy cost (or a relative energy cost) may be indicated as a negative value. For example, an energy cost associated with an NES action may have a negative energy cost (e.g., energy savings) in comparison to a current energy cost (which may be a non-NES mode of operation). In this example, the negative value may be considered an energy reward, energy benefit, or an energy savings value associated with the action. For example, the second network node 504 may indicate a negative energy cost/energy savings associated with a cell deactivation and/or a beam deactivation at the second network node 504.

In some aspects, the request 556 may include an indication, an indicator, or a flag that informs the second network node 504 that the request is for a granular energy cost associated with a configuration or action rather than a request for a general energy cost. For example, if the indicator includes a flag or bit, a value of 1 may indicate a request for granular energy cost information, and a value of 0 may indicate a request for general energy cost information. Similarly, a value of 0 may indicate a request for granular energy cost information, and a value of 1 may indicate a request for general energy cost information. These values are merely an example to illustrate the concept of indicating in the request to the second network node 504 whether the request is for a general energy cost or a granular energy cost.

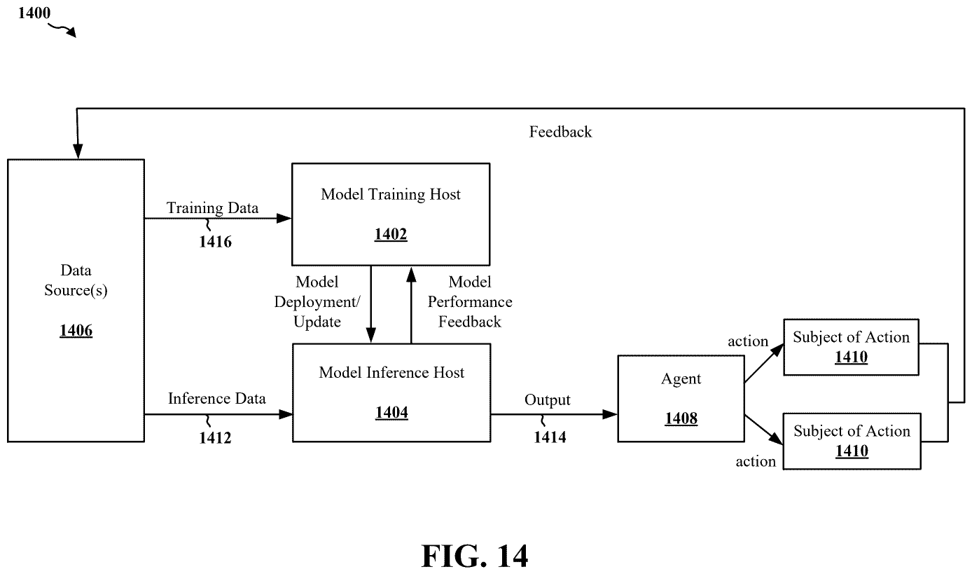

The collected data (e.g., the information provided from the second network node 504 to the first network node 502 at 558) can be used for AI/ML based training or AI/ML based decisions. As an example, the first network node may use the collected energy cost information to train an AI/ML model to assist the first network node 502 in making NES decisions, e.g., as described in connection with FIG. 14. In some aspects, the first network node 502 may use the collected energy cost information from the second network node 504 as input to obtain an AI/ML based inference or output with an NES decision or strategy for the first network node 502, e.g., as described in connection with any of FIGS. 13-15. In some aspects, the first network node may use the collected energy cost data from the second network node 504 to make a decision about its configuration (without an AI/ML model). In some aspects, the first network node 502 may use the collected energy cost information from the second network node 504 to determine (with or without an AI/ML model) to request a configuration change for the second network node (or a third network node). The configuration change, whether at the first network node or requested to be changed at the second network node, may relate to SSB transmission, RACH, paging, cell DTX/DRX, load balancing, handover, and/or capacity/coverage optimization (CCO), among other examples.

The energy cost information in the response 558 from the second network node 504 may include any of an energy cost, a relative energy cost, and/or a predicted energy cost. In some aspects, the energy cost may include an absolute cost (e.g., total energy cost rather than a relative or delta energy cost) associated with a particular configuration or action of the second network node 504. In some aspects, the second network node 504 may report a relative energy cost or delta energy cost in comparison to a current energy cost of the second network node. For example, the second network node 504 may report a relative energy cost (or delta energy cost) associated with an action indicated in the request. In some aspects, the energy cost may be an energy cost measured or otherwise determined by the second network node. In some aspects, the energy cost may be reported based on a current measurement/determination. In some aspects, the energy cost may be reported based on a prior measurement/determination. In some aspects, the second network node 504 may report a predicted energy cost for a configuration and/or action indicated in the request.

In some aspects, the energy cost associated with a particular configuration or action of the second network node may be predicted based on historical information. In some aspects, the prediction may be based on a model. In some aspects, the prediction may be obtained as output from a trained AI/ML model, which may include any of the aspects described in connection with FIGS. 13-15.

In some aspects, one of the network nodes may send a cell or beam activation request to the other network node that includes a predicted energy reward (e.g., a reduction in energy cost) associated with the request. For example, a first network node sending the request may indicate a predicted energy reward at the first network node if a second network node activates the cell/beam according to the request. FIG. 6B illustrates an example communication flow 600 between a first network node 602 and a second network node 604. The request and/or response in FIG. 6B may be exchanged over an Xn interface between the network nodes. In some aspects, the first network node 602 may correspond to the first network node 502, and the second network node 604 may correspond to the second network node 504. In some aspects, the communication in FIG. 6B may occur after, or before the communication illustrated in FIG. 5B. As illustrated at 606, the first network node 602 may send a request for the second network node 604 to adopt a configuration (e.g., associated with a cell, a beam, a group of cells, a group of beams, and/or a coverage state of the second network node) or take an action (e.g., activation or deactivate a cell, beam, cell DTX/DRX, on-demand SIB1, on demand SSB; reconfigure a beam; power reconfiguration; change of a periodicity; RACH adaptation; paging adaptation; and/or group handover). The request 606 may also include energy cost information related to the requested configuration or action. The configuration or action requested for the second network node may allow the first network node 602 to enter an NES mode and achieve a power savings, in some examples. For example, the energy cost information may indicate an energy savings to the first network node 602. As shown at 608, the second network node may send a response 608 to the request, e.g., either accepting or denying the request. In some aspects, the response 608 may include an indication of an energy cost at the second network node 604 (e.g., which may be referred to as the requested network node). As an example, the second network node 604 may reject the request if the energy cost to the second network node 604 is greater than the energy savings indicated for the first network node 602. In some aspects, the second network node 604 may accept the request and may implement or adopt the requested configuration or action if the energy savings to the first network node meets a metric, such as being greater than the energy cost to the second network node or meeting a threshold, among other examples. The exchange of energy cost information enables the network nodes to make more informed determinations about NES operation, and allows for coordination of NES across a wireless communication system, even with NES determinations by individual network nodes in a distributed manner and without a central entity making NES determinations.

The response 608 may include an indication of a new cause value if the request is not granted. As an example, the cause value may indicate that the energy cost at the requested node is high, higher than a threshold, or higher than an energy saving at the requesting node.

In some aspects, the request 606 may include, or indicate, a threshold on an incurred or a predicted energy cost associated with the request. In such examples, the second network node 604 may discard, ignore, or reject the request 606 if the incurred or predicted energy is greater than the indicated threshold. For example, the energy cost related information included in the request 606 may include the threshold in addition to, or alternatively to, energy savings information of the first network node 602.

In some aspects, the energy cost information may be included in the request 606 and excluded from the response 608. In some aspects, the energy cost information may be included in the response 608 and excluded from the request 606. In some aspects, the energy cost related information may be included in both the request 606 and the response 608.

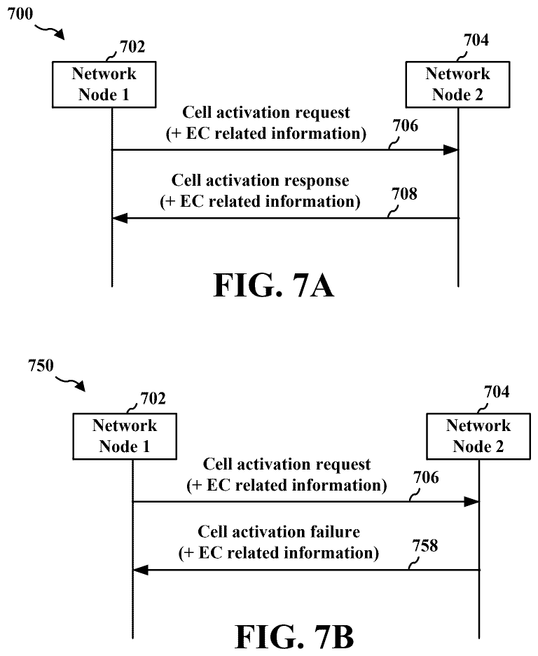

FIG. 7A illustrates an example communication flow 700 between a first network node 702 and a second network node 704. In some aspects, the first network node 702 may correspond to the first network node 502 or 602, and the second network node 704 may correspond to the second network node 504 or 604. The first network node 702 may send a request to the second network node 704 to activate a cell or activate a beam of the second network node 704. For example, the request 706 may indicate a set of cells or beams for activation or deactivation. FIG. 7A illustrates an example in which the request is a cell activation request. The request 706 may correspond to the request 606 in FIG. 6B, in some examples. The request and/or response in FIG. 7A may be exchanged over an Xn interface between the network nodes. As illustrated, the request 706 may include energy cost related information, e.g., including a predicted energy saving/cost at the first network node 702 if the second network node activates the requested cell or beam and/or information indicating a threshold associated an incurred cost at the second network node for the request. The second network node 704 sends a response 708 (e.g., a cell activation response) with energy cost related information. The response 708 may grant the request, for example. In some aspects, the response 708 may indicate energy cost information (e.g., incurred or predicted) for the second network node 704 associated with the requested cell activation.

In some aspects, the energy cost information may be included in the request 706 and excluded from the response 708. In some aspects, the energy cost information may be included in the response 708 and excluded from the request 706. In some aspects, the energy cost related information may be included in both the request and the response.

In some aspects, the second network node 704 may reject the request, e.g., as shown in the example communication flow 750 in FIG. 7B. The request and/or response in FIG. 7B may be exchanged over an Xn interface between the network nodes. For example, in the communication flow 750 in FIG. 7B, the second network node 704 may respond to the request 706 by sending a message indicating that the request is rejected or not granted. In some aspects, the response 758 may include a cell activation failure response. The response may include energy cost related information, such as indicating a predicted energy cost at the second network node. In some aspects, the response 758 may include a cause value that indicates that an energy cost is (or would be) exceeded for the second network node to activate the requested cell. The cause value may be explicitly indicated in the response 758 or may be implied by other information in the response.

FIG. 7B shows that at 706, the first network node 702 may provide a predicted energy/cost saving at first network node 702 and/or a threshold relating to an incurred additional cost at the second network node 704. At 758, the second network node 704 may respond by indicating a predicted additional energy cost at the second network node.

In some aspects, the energy cost information may be included in the request 706 and excluded from the response 758. In some aspects, the energy cost information may be included in the response 758 and excluded from the request 706. In some aspects, the energy cost related information may be included in both the request 706 and the response 758.

In some aspects, the network nodes (e.g., the first network node and the second network node) may exchange the information that can be used for predicting, estimating, and/or calculating the energy cost for different configurations, e.g. including different configurations at the first network node and the second network node. For example, the exchange of information enables the first network node to predict or estimate not only an energy savings from its NES operation, but also to estimate or predict an energy cost or energy savings that may be experienced by the second network node based on its NES operation.

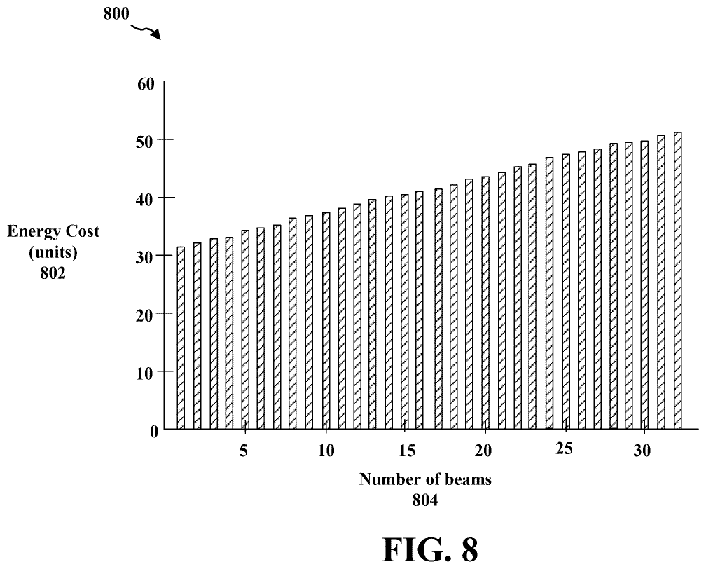

For example, FIG. 8 shows a graph 800 that illustrates a normalized energy cost of a cell (e.g., in an RRC idle mode) as function of a number of SSBs supported by (or transmitted by) the cell. The energy cost 802 is shown relative to the number of beams 804 used for the SSBs. In this example, the function for the energy cost at the network node can be approximated as f(x)=c+mx, wherein f represented the energy cost at the network node, x represented the number of SSBs transmitted by the network node, and c and m are constants related to deployment and configuration of the cell. The values for c and m (or the parameters associated with the energy cost function) can be shared among network nodes. For example the energy cost information provided by the second network node 504 in FIG. 5B may include parameters associated with an energy cost function of the second network node 504. This enables the first network node 502 to calculate the various energy costs for the second network node based on a variable configuration.

Network energy savings gains can be achieved through a global optimization solution that enables network nodes within a wireless communication system to coordinate through exchanged information to find an optimal set of cells and/or beams to be activated or deactivated, as well as SSB beamforming codebook selection, and/or SSB periodicity determination. The aspects presented herein improve an energy cost framework to make it more flexible and suitable to achieve theoretical NES gains.

For example, at a system level, there may be an energy saving for a network wide section optimization, which turns sectors of the network on and off, in comparison to a baseline without network energy savings. A network wide section optimization together with a per section beam optimization may provide increased energy savings. A network wide cost optimization as presented herein (with a consideration of energy cost at various network nodes) can provide a further energy savings. A network wide optimization with a mixed SSB periodicity can provide additional energy savings.

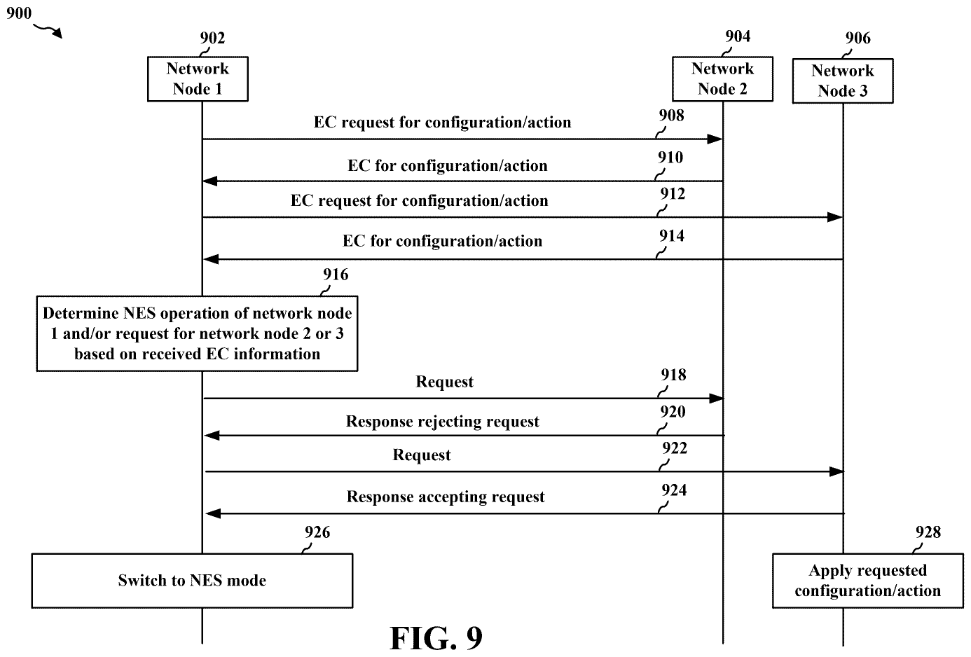

FIG. 9 is a communication flow 900 between a first network node 902, a second network node 904, and/or a third network node 906. The first network node may correspond to the first network node in any of FIGS. 5A-8, for example. The second network node 904 or the third network node 906 may correspond to the second network node in any of FIGS. 5A-8, for example.

The first network node sends the second network node a request 908 for an energy cost associated with one or more attributes for the second network node, where the request indicates the one or more attributes. The one or more attributes may include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs. The request may include any of the aspects described in connection with FIGS. 5B-8, for example.

The first network node 902 may send a similar request 912 to other network nodes as well, such as the third network node 906.

The second network node 904 and the third network node 906 send a response 910 and 914 to the first network node 902 with the requested energy cost information. For example, the request may correspond to 556 in FIG. 5B, and the response may correspond to 558 in FIG. 5B.

As illustrated at 916, the first network node 902 may use the received energy cost information from one or more network nodes to make a determination about an NES operation, such as switching to an NES mode and/or which NES operation to apply. In some aspects, the first network node may switch to the determined NES mode at 926. The determination, at 916 may be based on an AI/ML model, e.g., as discussed in connection with any of FIG. 13-15.

In some aspects, the first network node 902 may send a request 918 and/or 922 to one or more network nodes to request that the network node apply a configuration and/or an action. For example, the request may include any of the details described in connection with any of FIG. 6B-7B. The network nodes may send a response 920 or 924 accepting or rejecting the request. As shown at 928, the third network node 906 may accept the request and apply the requested configuration/action at 928. In some aspect, the first network node 902 may switch to the NES mode at 926 further based on the acceptance at 924.

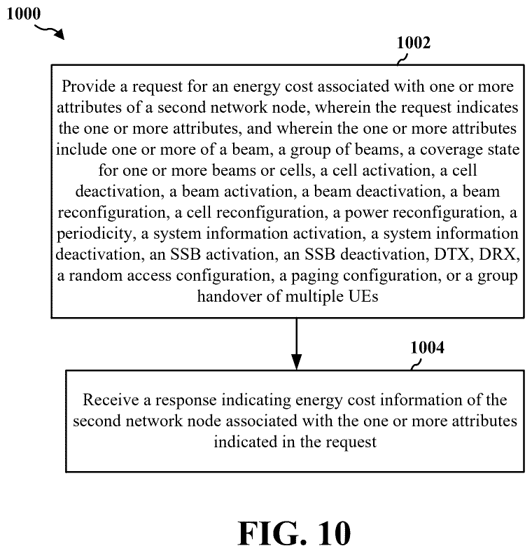

FIG. 10 is a flowchart 1000 of a method of wireless communication. The method may be performed by first network node such as a base station or one or more components of a base station (e.g., the base station 102; 202; 410; the CU 106, 210; the DU 105, 230; the RU 109, 240; the first network node 502, 602, 702, 902; the network entity 1202; first wireless device 1502). The method improves distributed network energy saving operation by exchanging energy cost information associated with particular configurations or actions between network nodes. The energy cost information enables the individual network nodes to make more informed determinations about their network energy saving operation and/or to coordinate adjustments at other network nodes based on network energy saving operations at the network node.

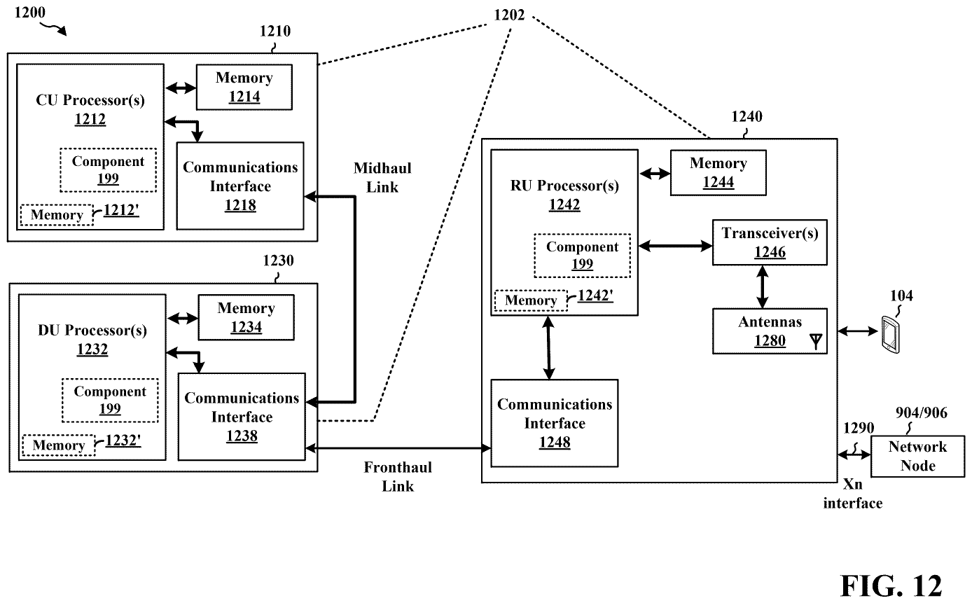

At 1002, the first network node provides a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs. FIGS. 5B-9 illustrate example communication flows with various aspects of requests associated with energy cost information and responses. The request may include any of the aspects described in connection with FIGS. 5B-9, for example. The request may be provided, e.g., by the NES component 199 of the network entity 1202 in FIG. 12, for example.

At 1004, the first network node receives a response indicating energy cost information of the second network node associated with the one or more attributes indicated in the request. The response may include any of the aspects described in connection with FIGS. 5B-9, for example. The reception of the response may be performed, e.g., by the NES component 199 of the network entity 1202 in FIG. 12, for example. In some aspects, the request and the response may be exchanged via an Xn interface between the first network node and the second network node.

For example, the one or more attributes indicated in the request may further include a cell level, and the response may indicate the energy cost information per cell of the second network node. The one or more attributes indicated in the request may further include the group of cells, and the response may indicate the energy cost information for the group of cells of the second network node. The one or more attributes indicated in the request may include the beam, and the response may indicate the energy cost information associated with the beam of the second network node. The one or more attributes indicated in the request may include the group of beams, and the response may indicate the energy cost information for the group of beams of the second network node. The one or more attributes indicated in the request may include the coverage state for the one or more beams, and the response may indicate the energy cost information associated with the coverage state for the one or more beams of the second network node. The one or more attributes indicated in the request may include the coverage state for one or more cells, and the response may indicate the energy cost information associated with the coverage state for the one or more cells of the second network node. The one or more attributes indicated in the request may include the beam activation, the beam deactivation, or the beam reconfiguration, and the response may indicate the energy cost information associated with the beam activation, the beam deactivation, or the beam reconfiguration for the second network node. The one or more attributes indicated in the request may include the cell activation, the cell deactivation, or the cell reconfiguration, and the response may indicate the energy cost information for the cell activation, the cell deactivation, or the cell reconfiguration for the second network node. The one or more attributes indicated in the request may include the power reconfiguration, and the response may indicate the energy cost information associated with the power reconfiguration for the second network node. The one or more attributes indicated in the request may include the periodicity of one or more signals of the second network node, and the response may indicate the energy cost information associated with the periodicity indicated in the request. The one or more attributes indicated in the request may include the system information activation or the system information deactivation, and the response may indicate the energy cost information associated with the system information activation or the system information deactivation for the second network node. The one or more attributes indicated in the request may include the SSB activation or the SSB deactivation, and the response may indicate the energy cost information associated with the SSB activation or the SSB deactivation for the second network node. The one or more attributes indicated in the request may include the DTX configuration, and the response may indicate the energy cost information associated with the DTX configuration for the second network node. The one or more attributes indicated in the request may include the DRX configuration, and the response may indicate the energy cost information associated with the DRX configuration for the second network node. The one or more attributes indicated in the request may include the random access configuration, and the response may indicate the energy cost information associated with the random access configuration for the second network node. The one or more attributes indicated in the request may include the paging configuration, and the response may indicate the energy cost information associated with the paging configuration for the second network node. The one or more attributes indicated in the request may include the group handover of the multiple UEs, and the response may indicate the energy cost information associated with the group handover of the multiple UEs for the second network node.

The energy cost information may include a predicted energy cost for an action of the second network node associated with the one or more attributes indicated in the request. The predicted energy cost may be based on an artificial intelligence or machine learning model. The energy cost information may indicate a relative cost in comparison to a current energy cost and associated with the one or more attributes indicated in the request. The relative cost may comprise a negative value indicating an energy saving associated with the one or more attributes indicated in the request.

The request may include a data collection request, and the response may include a data collection response.

In some aspects, the request may further request for the second network node to perform an action associated with the one or more attributes, and the response may include an acceptance or a rejection for the action, e.g., as described in connection with any of FIGS. 6B-9. The request may include one or more of a cell activation request or a beam activation request. The energy cost information may include one or more parameters of an energy cost function for the second network node.

In some aspects, the first network node may further change a configuration at the first network node or request a configuration change for the second network node based on the energy cost information received from the second network node.

In some aspects, the first network node may input the energy cost information of the second network node to a model and receive a configuration output for the configuration of the first network node based on the model.

In some aspects, the first network node may determine whether to activate a network energy saving (NES) configuration based on the energy cost information from the second network node.

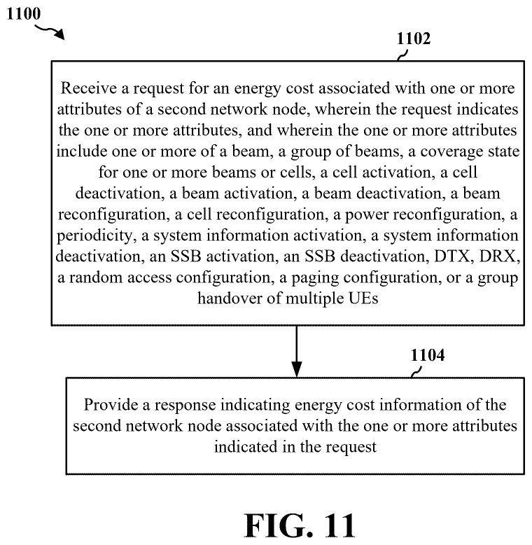

FIG. 11 is a flowchart 1100 of a method of wireless communication. The method may be performed by a second network node such as a base station or one or more components of a base station (e.g., the base station 102; 202; 410; the CU 106, 210; the DU 105, 230; the RU 109, 240; the second network node 504, 604, 704, 904; the network entity 1202; first wireless device 1502). The method improves distributed network energy saving operation by exchanging energy cost information associated with particular configurations or actions between network nodes. The energy cost information enables the individual network nodes to make more informed determinations about their network energy saving operation and/or to coordinate adjustments at other network nodes based on network energy saving operations at the network node.

At 1102, the second network node receives a request for an energy cost associated with one or more attributes for the second network node, where the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs. FIGS. 5B-9 illustrate example communication flows with various aspects of a requests associated with energy cost information and responses. The request may include any of the aspects described in connection with FIGS. 5B-9, for example. The reception of the request may be performed, e.g., by the NES component 199 of the network entity 1202 in FIG. 12, for example.

At 1104, the second network node provides a response indicating energy cost information of the second network node associated with the one or more attributes indicated in the request. The response may include any of the aspects described in connection with FIGS. 5B-9, for example. The response may be provided, e.g., by the NES component 199 of the network entity 1202 in FIG. 12, for example. In some aspects, the request and the response may be exchanged via an Xn interface between the first network node and the second network node.

For example, the one or more attributes indicated in the request may further include a cell level, and the response may indicate the energy cost information per cell of the second network node. The one or more attributes indicated in the request may further include the group of cells, and the response may indicate the energy cost information for the group of cells of the second network node. The one or more attributes indicated in the request may include the beam, and the response may indicate the energy cost information associated with the beam of the second network node. The one or more attributes indicated in the request may include the group of beams, and the response may indicate the energy cost information for the group of beams of the second network node. The one or more attributes indicated in the request may include the coverage state for the one or more beams, and the response may indicate the energy cost information associated with the coverage state for the one or more beams of the second network node. The one or more attributes indicated in the request may include the coverage state for one or more cells, and the response may indicate the energy cost information associated with the coverage state for the one or more cells of the second network node. The one or more attributes indicated in the request may include the beam activation, the beam deactivation, or the beam reconfiguration, and the response may indicate the energy cost information associated with the beam activation, the beam deactivation, or the beam reconfiguration for the second network node. The one or more attributes indicated in the request may include the cell activation, the cell deactivation, or the cell reconfiguration, and the response may indicate the energy cost information for the cell activation, the cell deactivation, or the cell reconfiguration for the second network node. The one or more attributes indicated in the request may include the power reconfiguration, and the response may indicate the energy cost information associated with the power reconfiguration for the second network node. The one or more attributes indicated in the request may include the periodicity of one or more signals of the second network node, and the response may indicate the energy cost information associated with the periodicity indicated in the request. The one or more attributes indicated in the request may include the system information activation or the system information deactivation, and the response may indicate the energy cost information associated with the system information activation or the system information deactivation for the second network node. The one or more attributes indicated in the request may include the SSB activation or the SSB deactivation, and the response may indicate the energy cost information associated with the SSB activation or the SSB deactivation for the second network node. The one or more attributes indicated in the request may include the DTX configuration, and the response may indicate the energy cost information associated with the DTX configuration for the second network node. The one or more attributes indicated in the request may include the DRX configuration, and the response may indicate the energy cost information associated with the DRX configuration for the second network node. The one or more attributes indicated in the request may include the random access configuration, and the response may indicate the energy cost information associated with the random access configuration for the second network node. The one or more attributes indicated in the request may include the paging configuration, and the response may indicate the energy cost information associated with the paging configuration for the second network node. The one or more attributes indicated in the request may include the group handover of the multiple UEs, and the response may indicate the energy cost information associated with the group handover of the multiple UEs for the second network node

In some aspects, the second network node may further predict the energy cost based on the one or more attributes indicated in the request, wherein the energy cost information includes a predicted energy cost for an action of the second network node associated with the one or more attributes indicated in the request.

The energy cost information may include a predicted energy cost for an action of the second network node associated with the one or more attributes indicated in the request. The predicted energy cost may be based on an artificial intelligence or machine learning model. The energy cost information may indicate a relative cost in comparison to a current energy cost and associated with the one or more attributes indicated in the request. The relative cost may comprise a negative value indicating an energy saving associated with the one or more attributes indicated in the request.

The request may include a data collection request, and the response may include a data collection response.

In some aspects, the request may further request for the second network node to perform an action associated with the one or more attributes, and the response may include an acceptance or a rejection for the action, e.g., as described in connection with any of FIGS. 6B-9. The request may include one or more of a cell activation request or a beam activation request. The energy cost information may include one or more parameters of an energy cost function for the second network node.

FIG. 12 is a diagram 1200 illustrating an example of a hardware implementation for a network entity 1202. In some aspects, the network entity may correspond to the first network node in any of FIGS. 5A-9. The network entity 1202 may be referred to interchangeably as a network node. In some aspects, the network entity may correspond to the second network node in any of FIGS. 5A-9. In some aspects, the network entity may correspond to the third network node in FIG. 9. The network entity 1202 may be a base station, a component of a base station, and/or may implement base station functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′,1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs and receive a response indicating energy cost information of the second network node associated with the one or more attributes indicated in the request. In some aspects, the NES component 199 may be configured to receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, an SSB activation, an SSB deactivation, DTX, DRX, a random access configuration, a paging configuration, or a group handover of multiple UEs; and provide a response indicating energy cost information of the second network node associated with the one or more attributes indicated in the request. In some aspects, the request and/or the response may be exchanged with the network node (e.g., 904 or 906) via an Xn interface 1290, for example. The component 199 and/or the network entity may be further configured to perform any of the details described in connection with the flowcharts in FIG. 10 or FIG. 11, and/or any of the communication flows described in connection with FIG. 5A-9. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs; and means for receiving a response indicating energy cost information of the second network node associated with the one or more attributes indicated in the request. In some aspects, the network entity may further include means for receiving a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs; and means for providing a response indicating energy cost information of the second network node associated with the one or more attributes indicated in the request. The network entity may further include means for performing any of the details described in connection with the flowcharts in FIG. 10 or FIG. 11, and/or any of the communication flows described in connection with FIG. 5A-9. The means may be the component 199 of the network entity 1202 configured to perform the functions recited by the means. As described supra, the network entity 1202 may include the TX processor 416, the RX processor 470, and the controller/processor 475. As such, in one configuration, the means may be the TX processor 416, the RX processor 470, and/or the controller/processor 475 configured to perform the functions recited by the means.

Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more of decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets which may indicate a starting point for outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to predict an optimal network node operation, including the consideration of one or more NES modes or NES operations. The ML model may be used for a distributed approach for system-wide NES, e.g., as described herein. Thus, during operation of a device (e.g., a network node such as a base station), the ML model may receive input data (such as granular energy cost information from one or more neighbor network nodes, as described in connection with any of FIGS. 5B-9) based on the weights and biases. The ML model may be employed to assist the network node in NES operation, such as determining whether to employ NES operation and/or which NES operation to employ. Examples of NES operation may include any of modified SSB transmission such as a reduction in SSB transmission, an increase in SSB periodicity, or a use of on-demand SSB transmission; cell discontinuous transmission (DTX)/discontinuous reception (DRX); cell deactivation; beam deactivation; change in periodicity of system information such as use of on-demand SIB transmission (e.g., SIB1 transmission in response to a UE request); adaptations to RACH resources such as reduced RACH occasions; adaptations to paging; adaptations or reductions to common signals or common channel transmissions (e.g., SSB, PRACH resources, paging, etc.), and/or handover of UEs, among other examples of a mode or operation that can provide energy savings at a network node.

ML models may be deployed in one or more devices (for example, network entities and/or user equipments (UEs)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, etc. ML models may be used to perform different tasks such as classification or regression, where classification refers to determining one or more discrete output values from a set of predefined output values, and regression refers to determining continuous values which are not bounded by predefined output values. For example, a classification ML model configured according to aspects of this disclosure may produce an output which includes assists the network node in determining whether to employ NES operation and/or which NES operation to employ. A regression ML model configured according to embodiments of this disclosure may produce an output which includes determining whether to employ NES operation and/or which NES operation to employ. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models in a distributed system-wide NES scheme. To facilitate the discussion, an ML model configured using an ANN is used, but it should be understood, that other types of ML models may be used instead of an ANN. Hence, unless expressly recited, subject matter regarding an ML model is not necessarily intended to be limited to an ANN solution. Further, it should be understood that, unless otherwise specifically stated, terms such “AI/ML model,” “ML model,” “trained ML mode,” “ANN,” “model,” “algorithm,” or the like are intended to be interchangeable.

FIG. 13 is an illustrative block diagram of an example machine learning (ML) model represented by an artificial neural network (ANN) 1300. The ML model may be used for a distributed approach for system-wide NES, e.g., as described herein. ANN 1300 may receive input data 1306 which may include one or more bits of data 1302, pre-processed data output from pre-processor 1304 (optional), or some combination thereof. Here, data 1302 may include training data, verification data, application-related data, or the like, based, for example, on the stage of deployment of ANN 1300. Pre-processor 1304 may be included within ANN 1300 in some other implementations. Pre-processor 1304 may, for example, process all or a portion of data 1302 which may result in some of data 1302 being changed, replaced, deleted, etc. In some implementations, pre-processor 1304 may add additional data to data 1302. In some implementations, the pre-processor 1304 may be a ML model, such as an ANN.

The ANN 1300 includes at least one first layer 1308 of artificial neurons 1310 to process input data 1306 and provide resulting first layer data via connections or “edges” such as edges 1312 to at least a portion of at least one second layer 1314. Second layer 1314 processes data received via edges 1312 and provides second layer output data via edges 1316 to at least a portion of at least one third layer 1318. Third layer 1318 processes data received via edges 1316 and provides third layer output data via edges 1320 to at least a portion of a final layer 1322 including one or more neurons to provide output data 1324. All or part of output data 1324 may be further processed in some manner by (optional) post-processor 1326. Thus, in certain examples, ANN 1300 may provide output data 1328 that is based on output data 1324, post-processed data output from post-processor 1326, or some combination thereof.

Post-processor 1326 may be included within ANN 1300 in some other implementations. Post-processor 1326 may, for example, process all or a portion of output data 1324 which may result in output data 1328 being different, at least in part, to output data 1324, as result of data being changed, replaced, deleted, etc. In some implementations, post-processor 1326 may be configured to add additional data to output data 1324. In this example, second layer 1314 and third layer 1318 represent intermediate or hidden layers that may be arranged in a hierarchical or other like structure. Although not explicitly shown, there may be one or more further intermediate layers between the second layer 1314 and the third layer 1318. In some implementations, the post-processor 1326 may be a ML model, such as an ANN.

The structure and training of artificial neurons 1310 in the various layers may be tailored to specific requirements of an application. Within a given layer such as first layer 1308, second layer 1314, or third layer 1318 of ANN 1300, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 1300. The weights and biases of ANN 1300 may be adjusted during a training process or during operation of ANN 1300. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 1306. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 1300, may be conducted using training data. Training data may include one or more datasets which ANN 1300 may use to identify patterns or relationships. Training data may represent various types of information, including written, visual, audio, environmental context, operational properties, etc. During training, the parameters (such as the weights and biases) of artificial neurons 1310 may be changed, such as to minimize or otherwise reduce a loss function or a cost function. A training process may be repeated multiple times to fine-tune ANN 1300 with each iteration.

Various ANN model structures are available for consideration. For example, in a feedforward ANN structure, each artificial neuron 1310 in layer 1314 receives information from the previous layer (such as, one or more artificial neurons 1310 in layer 1308) and produces information for the next layer (such as, one or more artificial neurons 1310 in layer 1318). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 1300 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by a NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to a RF transceiver based on the outputs or inferences obtained from an ML model to cause the RF transceiver to operate on a wireless network in accordance with the ML model.

In example aspects, an ML model may be trained prior to, or at some point following, operation of the ML model, such as ANN 1300, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a user equipment (UE) or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In certain instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model. As described herein, network nodes may collaborate by exchanging energy cost information to assist in a distributed NES scheme.

In some implementations, one or more devices or services may support processes relating to a ML model's usage, maintenance, activation, reporting, or the like. In certain instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a UE, a network entity such as a base station, or a disaggregated network entity such as a central unit (CU), a distributed unit (DU), a radio unit (RU), or the like.

FIG. 14 is an illustrative block diagram of an example ML architecture 1400 that may be used for wireless communications in any of the various implementations, processes, environments, networks, or use cases listed above. The ML model may be used for a distributed approach for system-wide NES, e.g., as described herein. As illustrated, architecture 1400 includes multiple logical entities, such as model training host 1402, model inference host 1404, data source(s) 1406, and agent 1408. Model inference host 1404 is configured to run an ML model based on inference data 1412 provided by data source(s) 1406. Model inference host 1404 may produce output 1414, which may include a prediction or inference, such as a discrete or continuous value based on inference data 1412, which may then be provided as input to the agent 1408.

Agent 1408 may represent an element or an entity of a wireless communication system including, for example, a radio access network (RAN), a wireless local area network, a device-to-device (D2D) communications system, etc. As an example, agent 1408 may be a user equipment (such as UE 104, referring to FIG. 1, for example), a base station (such as base station 102, referring to FIG. 1, for example), or a disaggregated network entity (such as a CU 106, DU 105, or RU 109 in FIG. 1), an access point, a wireless station, a RAN intelligent controller (RIC) in a cloud-based RAN, among some examples. Additionally, agent 1408 also may be a type of agent that depends on the type of tasks performed by model inference host 1404, the type of inference data 1412 provided to model inference host 1404, or the type of output 1414 produced by model inference host 1404. For example, the output may indicate whether a network node is to employ NES operation and/or which NES operation to employ.

Agent 1408 may perform one or more actions associated with receiving output 1414 from model inference host 1404. For example, the output may trigger the network node to employ an NES mode or NES operation and/or may be used by the network node to determine to employ or enter an NES mode or NES operation. Agent 1408 may indicate the one or more actions performed to at least one subject of action 1410. In some cases, agent 1408 and the subject of action 1410 are the same entity.

Data can be collected from data sources 1406, and may be used as training data 1416 for training an ML model, or as inference data 1412 for feeding an ML model inference operation. Data sources 1406 may collect data from various subject of action 1410 entities (such as, the UE or the network entity), and provide the collected data to a model training host 1402 for ML model training. For example a network node may provide feedback based on a result associated with an NES decision based on the output. In some examples, if output 1414 provided to agent 1408 is inaccurate (or the accuracy is below an accuracy threshold), model training host 1402 may provide feedback to model inference host 1404 to modify or retrain the ML model used by model inference host 1404, such as via an ML model deployment update.

Model training host 1402 may be deployed at the same or a different entity than that in which model inference host 1404 is deployed. For example, in order to offload model training processing, which can impact the performance of model inference host 1404, model training host 1402 may be deployed at a model server 1550.

In some aspects, an ML model is deployed at or on a network entity (such as a base station 102) for determining whether to employ NES operation and/or which NES operation to employ. More specifically, a model inference host, such as model inference host 1404 in FIG. 14, may be deployed at or on the network entity for such determinations about whether to employ NES operation and/or which NES operation to employ.

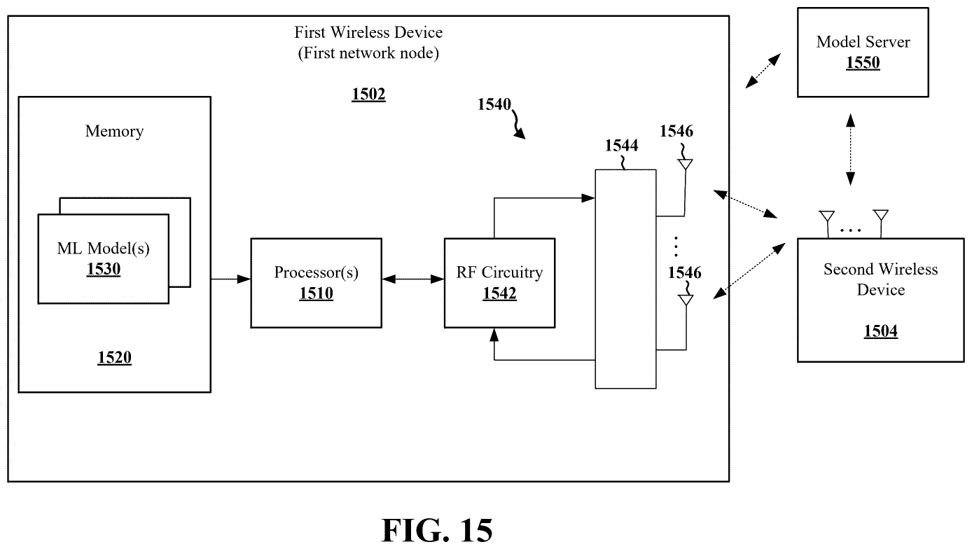

FIG. 15 is an illustrative block diagram of an example ML architecture of first wireless device 1502 in communication with second wireless device 1504. First wireless device 1502 may be a network node that supports NES operation or NES modes, and which is configured to exchange, or receive, energy cost information from other network nodes to use as input to the ML model to determining whether to employ NES operation and/or which NES operation to employ. The ML model may be trained for a distributed approach for system-wide NES, e.g., as described herein. Similarly, the second wireless device may be a second network node that is configured to provide energy cost information to the first wireless device, as described herein. Note that the example ML architecture of first wireless device 1502 may be applied to second wireless device 1504, and vice versa. In some aspects, the second wireless device 1504 may be a UE that is served by the first wireless device.

First wireless device 1502 may be, or may include, a chip, system on chip (SoC), chipset, package or device that includes one or more processors, processing blocks or processing elements (collectively “processor 1510”) and one or more memory blocks or elements (collectively “memory 1520”). Processor 1510 may be coupled to transceiver 1544, which includes radio frequency (RF) circuitry 1542 coupled to antennas 1546 via an interface, for transmitting or receiving signals.

One or more ML models 1530 (collectively “ML model 1530”) may be stored in memory 1520 and accessible to processor(s) 1510. Individual or groups of ML models 1530 may be associated with respective model identifiers. In some aspects, different ML models 1530, which may optionally be associated with different model identifiers, may have different characteristics. One or more ML models 1530 may be selected based on respective features, characteristics, or applications, as well as characteristics or conditions of first wireless device 1540 (such as, a power state, a mobility state, a battery reserve, a temperature, etc.). For example, ML models 1530 may have different inference data and output pairings (such as, different types of inference data produce different types of output), different levels of accuracies associated with the predictions, different latencies.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S S F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is a method of wireless communication at a first network node, comprising: providing a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs; and receiving a response indicating energy cost information of the second network node associated with the one or more attributes indicated in the request.

In aspect 2, the method of aspect 1 further includes that the one or more attributes indicated in the request further include a cell level, and wherein the response indicates the energy cost information per cell of the second network node, or wherein the one or more attributes indicated in the request further include a group of cells, and wherein the response indicates the energy cost information for the group of cells of the second network node.

In aspect 3, the method of aspect 1 or 2 further includes that the one or more attributes indicated in the request include the beam, and wherein the response indicates the energy cost information associated with the beam of the second network node, or wherein the one or more attributes indicated in the request include the group of beams, and wherein the response indicates the energy cost information for the group of beams of the second network node.

In aspect 4, the method of any of aspects 1-3 further includes that the one or more attributes indicated in the request include the coverage state for the one or more beams, and wherein the response indicates the energy cost information associated with the coverage state for the one or more beams of the second network node, or wherein the one or more attributes indicated in the request include the coverage state for one or more cells, and wherein the response indicates the energy cost information associated with the coverage state for the one or more cells of the second network node.

In aspect 5, the method of any of aspects 1-4 further includes that the one or more attributes indicated in the request include the beam activation, the beam deactivation, or the beam reconfiguration, and wherein the response indicates the energy cost information associated with the beam activation, the beam deactivation, or the beam reconfiguration for the second network node, or wherein the one or more attributes indicated in the request include the cell activation, the cell deactivation, or the cell reconfiguration, and wherein the response indicates the energy cost information for the cell activation, the cell deactivation, or the cell reconfiguration for the second network node.

In aspect 6, the method of any of aspects 1-5 further includes that the one or more attributes indicated in the request include the power reconfiguration, and wherein the response indicates the energy cost information associated with the power reconfiguration for the second network node.

In aspect 7, the method of any of aspects 1-6 further includes that the one or more attributes indicated in the request include the periodicity of one or more signals of the second network node, and wherein the response indicates the energy cost information associated with the periodicity indicated in the request.

In aspect 8, the method of any of aspects 1-7 further includes that the one or more attributes indicated in the request include the system information activation or the system information deactivation, and wherein the response indicates the energy cost information associated with the system information activation or the system information deactivation for the second network node, or wherein the one or more attributes indicated in the request include the SSB activation or the SSB deactivation, and wherein the response indicates the energy cost information associated with the SSB activation or the SSB deactivation for the second network node.

In aspect 9, the method of any of aspects 1-8 further includes that the one or more attributes indicated in the request include the DTX configuration, and wherein the response indicates the energy cost information associated with the DTX configuration for the second network node, or wherein the one or more attributes indicated in the request include the DRX configuration, and wherein the response indicates the energy cost information associated with the DRX configuration for the second network node.

In aspect 10, the method of any of aspects 1-9 further includes that the one or more attributes indicated in the request include the random access configuration, and wherein the response indicates the energy cost information associated with the random access configuration for the second network node, or wherein the one or more attributes indicated in the request include the paging configuration, and wherein the response indicates the energy cost information associated with the paging configuration for the second network node.

In aspect 11, the method of any of aspects 1-10 further includes that the one or more attributes indicated in the request include the group handover of the multiple UEs, and wherein the response indicates the energy cost information associated with the group handover of the multiple UEs for the second network node.

In aspect 12, the method of any of aspects 1-10 further includes that the energy cost information includes a predicted energy cost for an action of the second network node associated with the one or more attributes indicated in the request.

In aspect 13, the method of aspect 12 further includes that the predicted energy cost is based on an artificial intelligence or machine learning model.

In aspect 14, the method of any of aspects 1-13 further includes that the energy cost information indicates a relative cost in comparison to a current energy cost and associated with the one or more attributes indicated in the request.

In aspect 15, the method of aspect 14 further includes that the relative cost comprises a negative value indicating an energy saving associated with the one or more attributes indicated in the request.

In aspect 16, the method of any of aspects 1-15 further includes that the request includes a data collection request, and wherein the response includes a data collection response.

In aspect 17, the method of any of aspects 1-16 further includes that the request further requests the second network node to perform an action associated with the one or more attributes, and wherein the response includes an acceptance or a rejection for the action.

In aspect 18, the method of any of aspects 1-17 further includes that the request includes one or more of a cell activation request or a beam activation request.

In aspect 19, the method of any of aspects 1-11 or 16-18 further includes that the energy cost information includes one or more parameters of an energy cost function for the second network node.

In aspect 20, the method of any of aspects 1-19 further includes changing a configuration at the first network node or requesting a configuration change for the second network node based on the energy cost information received from the second network node.

In aspect 21, the method of any of aspects 1-20 further includes inputting the energy cost information of the second network node to a model; and receiving a configuration output for the configuration of the first network node based on the model.

In aspect 22, the method of any of aspects 1-21 further includes determining whether to activate a network energy saving (NES) configuration based on the energy cost information from the second network node.

Aspect 23 is a method of wireless communication at a second network node, comprising: receiving a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple UEs; and providing a response indicating energy cost information of the second network node associated with the one or more attributes indicated in the request.

In aspect 24, the method of aspect 23 further includes that the one or more attributes indicated in the request further include a cell level, and wherein the response indicates the energy cost information per cell of the second network node, or wherein the one or more attributes indicated in the request further include a group of cells, and wherein the response indicates the energy cost information for the group of cells of the second network node.

In aspect 25, the method of any of aspects 23 or 24 further includes that the one or more attributes indicated in the request include the beam, and wherein the response indicates the energy cost information associated with the beam of the second network node, or wherein the one or more attributes indicated in the request include the group of beams, and wherein the response indicates the energy cost information for the group of beams of the second network node.

In aspect 26, the method of any of aspects 23-25 further includes that the one or more attributes indicated in the request include the coverage state for the one or more beams, and wherein the response indicates the energy cost information associated with the coverage state for the one or more beams of the second network node, or wherein the one or more attributes indicated in the request include the coverage state for one or more cells, and wherein the response indicates the energy cost information associated with the coverage state for the one or more cells of the second network node.

In aspect 27, the method of any of aspects 23-26 further includes that the one or more attributes indicated in the request include the beam activation, the beam deactivation, or the beam reconfiguration, and wherein the response indicates the energy cost information associated with the beam activation, the beam deactivation, or the beam reconfiguration for the second network node, or wherein the one or more attributes indicated in the request include the cell activation, the cell deactivation, or the cell reconfiguration, and wherein the response indicates the energy cost information for the cell activation, the cell deactivation, or the cell reconfiguration for the second network node.

In aspect 28, the method of any of aspects 23-27 further includes that the one or more attributes indicated in the request include the power reconfiguration, and wherein the response indicates the energy cost information associated with the power reconfiguration for the second network node.

In aspect 29, the method of any of aspects 23-28 further includes that the one or more attributes indicated in the request include the periodicity of one or more signals of the second network node, and wherein the response indicates the energy cost information associated with the periodicity indicated in the request.

In aspect 30, the method of any of aspects 23-29 further includes that the one or more attributes indicated in the request include the system information activation or the system information deactivation, and wherein the response indicates the energy cost information associated with the system information activation or the system information deactivation for the second network node, or wherein the one or more attributes indicated in the request include the SSB activation or the SSB deactivation, and wherein the response indicates the energy cost information associated with the SSB activation or the SSB deactivation for the second network node.

In aspect 31, the method of any of aspects 23-30 further includes that the one or more attributes indicated in the request include the DTX configuration, and wherein the response indicates the energy cost information associated with the DTX configuration for the second network node, or wherein the one or more attributes indicated in the request include the DRX configuration, and wherein the response indicates the energy cost information associated with the DRX configuration for the second network node.

In aspect 32, the method of any of aspects 23-31 further includes that the one or more attributes indicated in the request include the random access configuration, and wherein the response indicates the energy cost information associated with the random access configuration for the second network node, or wherein the one or more attributes indicated in the request include the paging configuration, and wherein the response indicates the energy cost information associated with the paging configuration for the second network node.

In aspect 33, the method of any of aspects 23-32 further includes that the one or more attributes indicated in the request include the group handover of the multiple UEs, and wherein the response indicates the energy cost information associated with the group handover of the multiple UEs for the second network node.

In aspect 34, the method of clause 23, further comprising: predicting the energy cost based on the one or more attributes indicated in the request, wherein the energy cost information includes a predicted energy cost for an action of the second network node associated with the one or more attributes indicated in the request.

In aspect 35, the method of aspect 34 further includes that the predicted energy cost is based on an artificial intelligence or machine learning model.

In aspect 36, the method of any of aspects 23-35 further includes that the energy cost information indicates a relative cost in comparison to a current energy cost and associated with the one or more attributes indicated in the request.

In aspect 37, the method of aspect 36 further includes that the relative cost comprises a negative value indicating an energy saving associated with the one or more attributes indicated in the request.

In aspect 38, the method of any of aspects 23-37 further includes that the request includes a data collection request, and wherein the response includes a data collection response.

In aspect 39, the method of any of aspects 23-38 further includes that the request further requests the second network node to perform an action associated with the one or more attributes, and wherein the response includes an acceptance or a rejection for the action.

In aspect 40, the method of any of aspects 23-39 further includes that the request includes one or more of a cell activation request or a beam activation request.

In aspect 41, the method of any of aspects 23-33 or 38-40 further includes that the energy cost information includes one or more parameters of an energy cost function for the second network node.

Aspect 42 is an apparatus for wireless communication at a first network node, comprising: one or more memories; and one or more processors coupled to the one or more memories and configured to cause the first network node to perform the method of any of aspects 1-22.

Aspect 43 is an apparatus for wireless communication at a first network node, comprising means for performing each step in the method of any of aspects 1-22.

Aspect 44 is a first network entity comprising: a processing system that includes processor circuitry and memory circuitry that stores code and is coupled with the processor circuitry, the processing system configured to cause the first network entity to: perform the method of any of aspects 1-22.

Aspect 45 is the apparatus of any of aspects 42-44, further comprising a transceiver configured to receive or to transmit in association with the method of any of aspects 1-22.

Aspect 46 is a computer-readable storage medium (e.g., a non-transitory computer-readable storage medium) storing computer executable code at a first network node, the code when executed by at least one processor causes the first network node to perform the method of any of aspects 1-22.

Aspect 47 is an apparatus for wireless communication at a second network node, comprising: one or more memories; and one or more processors coupled to the one or more memories and configured to cause the second network node to perform the method of any of aspects 23-41.

Aspect 48 is an apparatus for wireless communication at a second network node, comprising means for performing each step in the method of any of aspects 23-41.

Aspect 49 is a second network entity comprising: a processing system that includes processor circuitry and memory circuitry that stores code and is coupled with the processor circuitry, the processing system configured to cause the second network entity to: perform the method of any of aspects 23-41.

Aspect 50 is the apparatus of any of aspects 47-49, further comprising a transceiver configured to receive or to transmit in association with the method of any of aspects 23-41.

Aspect 51 is a computer-readable storage medium (e.g., a non-transitory computer-readable storage medium) storing computer executable code at a second network node, the code when executed by at least one processor causes the second network node to perform the method of any of aspects 23-41.

What is claimed is:

1. An apparatus for wireless communication at a first network node, comprising:
one or more memories; and
one or more processors coupled to the one or more memories and configured to cause the first network node to:
provide a request for an energy cost associated with one or more attributes of a second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation,
discontinuous transmission (DTX), discontinuous reception (DRX), a random access configuration, a paging configuration, or a group handover of multiple user equipment (UEs); and
receive a response that indicates energy cost information of the second network node associated with the one or more attributes indicated in the request.

2. The apparatus of claim 1, wherein the one or more attributes indicated in the request further include a cell level, and wherein the response indicates the energy cost information per cell of the second network node, or
wherein the one or more attributes indicated in the request further include a group of cells, and wherein the response indicates the energy cost information for the group of cells of the second network node.

3. The apparatus of claim 1, wherein the one or more attributes indicated in the request include the beam, and wherein the response indicates the energy cost information associated with the beam of the second network node, or
wherein the one or more attributes indicated in the request include the group of beams, and wherein the response indicates the energy cost information for the group of beams of the second network node.

4. The apparatus of claim 1, wherein the one or more attributes indicated in the request include the coverage state for the one or more beams, and wherein the response indicates the energy cost information associated with the coverage state for the one or more beams of the second network node, or
wherein the one or more attributes indicated in the request include the coverage state for one or more cells, and wherein the response indicates the energy cost information associated with the coverage state for the one or more cells of the second network node.

5. The apparatus of claim 1, wherein the one or more attributes indicated in the request include the beam activation, the beam deactivation, or the beam reconfiguration, and wherein the response indicates the energy cost information associated with the beam activation, the beam deactivation, or the beam reconfiguration for the second network node, or
wherein the one or more attributes indicated in the request include the cell activation, the cell deactivation, or the cell reconfiguration, and wherein the response indicates the energy cost information for the cell activation, the cell deactivation, or the cell reconfiguration for the second network node.

6. The apparatus of claim 1, wherein the one or more attributes indicated in the request include the power reconfiguration, and wherein the response indicates the energy cost information associated with the power reconfiguration for the second network node.

7. The apparatus of claim 1, wherein the one or more attributes indicated in the request include the periodicity of one or more signals of the second network node, and wherein the response indicates the energy cost information associated with the periodicity indicated in the request.

8. The apparatus of claim 1, wherein the one or more attributes indicated in the request include the system information activation or the system information deactivation, and wherein the response indicates the energy cost information associated with the system information activation or the system information deactivation for the second network node, or
wherein the one or more attributes indicated in the request include the SSB activation or the SSB deactivation, and wherein the response indicates the energy cost information associated with the SSB activation or the SSB deactivation for the second network node.

9. The apparatus of claim 1, wherein the one or more attributes indicated in the request include the DTX configuration, and wherein the response indicates the energy cost information associated with the DTX configuration for the second network node, or
wherein the one or more attributes indicated in the request include the DRX configuration, and wherein the response indicates the energy cost information associated with the DRX configuration for the second network node.

10. The apparatus of claim 1, wherein the one or more attributes indicated in the request include the random access configuration, and wherein the response indicates the energy cost information associated with the random access configuration for the second network node, or
wherein the one or more attributes indicated in the request include the paging configuration, and wherein the response indicates the energy cost information associated with the paging configuration for the second network node.

11. The apparatus of claim 1, wherein the one or more attributes indicated in the request include the group handover of the multiple UEs, and wherein the response indicates the energy cost information associated with the group handover of the multiple UEs for the second network node.

12. The apparatus of claim 1, wherein the energy cost information includes a predicted energy cost for an action of the second network node associated with the one or more attributes indicated in the request.

13. The apparatus of claim 12, wherein the predicted energy cost is based on an artificial intelligence or machine learning model.

14. The apparatus of claim 1, wherein the energy cost information indicates a relative cost in comparison to a current energy cost and associated with the one or more attributes indicated in the request.

15. The apparatus of claim 14, wherein the relative cost comprises a negative value that indicates an energy saving associated with the one or more attributes indicated in the request.

16. The apparatus of claim 1, wherein the request includes a data collection request, and wherein the response includes a data collection response.

17. The apparatus of claim 1, wherein the request further requests the second network node to perform an action associated with the one or more attributes, and wherein the response includes an acceptance or a rejection for the action.

18. The apparatus of claim 1, wherein the energy cost information includes one or more parameters of an energy cost function for the second network node.

19. The apparatus of claim 1, wherein the one or more processors are further configured to cause the first network node to:
change a configuration at the first network node or request a configuration change for the second network node based on the energy cost information received from the second network node.

20. An apparatus for wireless communication at a second network node, comprising:
one or more memories; and
one or more processors coupled to the one or more memories and configured to cause the second network node to:
receive a request for an energy cost associated with one or more attributes for the second network node, wherein the request indicates the one or more attributes, and wherein the one or more attributes include one or more of a beam, a group of beams, a coverage state for one or more beams or cells, a cell activation, a cell deactivation, a beam activation, a beam deactivation, a beam reconfiguration, a cell reconfiguration, a power reconfiguration, a periodicity, a system information activation, a system information deactivation, a synchronization signal block (SSB) activation, an SSB deactivation, discontinuous transmission (DTX), discontinuous reception (DRX), a random access configuration, a paging configuration, or a group handover of multiple user equipment (UEs); and
provide a response that indicates energy cost information of the second network node associated with the one or more attributes indicated in the request.
